(19) United States
(12) Patent Application Publication
(10) Pub. No.: US 2009/0019945 A1
(43) Pub. Date: Jan. 22, 2009

(54) Ultrasonic Flowmaster

(76) Inventor: Shigetada Matsushita, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/577,100

(22) PCT Filed: Oct. 6, 2005
(86) PCT No.: PCT/JP05/18522

§ 371 Date: Apr. 12, 2007

(30) Foreign Application Priority Data
Oct. 13, 2004 (JP) 2004-298456

(51) Int. Cl. G01F 1/66

(52) U.S. Cl. 73/861.28

(57) ABSTRACT

In an ultrasonic flowmeter of the time difference type using annular ultrasonic transducers, to obtain an accurate flow volume without correction by actual flow, from theoretical formulas which are taking properties of the fluid such as density, and dimension, and properties of the measuring tube into consideration.

The flowmeter is equipped with an ultrasonic measuring device which measures the downstream running time T₁, the upstream running time T₂, and period Tₚ or frequency fₚ of propagating ultrasonic wave; and a computing device which conducts first calculation for outputting a running time difference ΔT, a mean running time T₀, and a natural angular frequency ω₀ by inputting the above measured data, conducts second calculation for outputting a sound velocity c in the fluid from a distance L between the two ultrasonic transducers, an inside radius a of the measuring tube, a damping coefficient R of tube wall oscillation of the measuring tube, a density ρ of the fluid, the above-mentioned T₀ and the above-mentioned ω₀, and conducts third calculation for outputting the flow speed V of the fluid from the above-mentioned ΔT, T₀, L and c.

### TECHNICAL FIELD

The present invention relates to an ultrasonic flowmeter of so-called time difference type, in which two annular ultrasonic transducers are set at a distance each other as being penetrated by a measuring tube and touching to the measuring tube, and the ultrasonic transducers are operated as an ultrasonic sender and an ultrasonic receiver alternately, and then, flow speed is calculated by measuring an upstream running time and downstream running time of the ultrasonic wave.

### BACKGROUND ART

The ultrasonic flowmeter has advantages that measurement can be performed by outside of the flow tube, there is entirely no pressure loss accompanied by the measurement, and each of the forward and reverse flow can be measured from a zero flow speed. The ultrasonic flowmeters can be classified in principles to a time difference type and a Doppler type. The time difference type is more popular than the Doppler type because of high precision. As a usual construction of the time difference type, two wedge-shaped ultrasonic transducers are set outside of a tube by diagonally facing each other across the tube, and the two ultrasonic transducers are operated as an ultrasonic sender and an ultrasonic receiver alternately. Then, the flow speed can be determined by measuring running times of the ultrasonic wave for an upstream direction and a downstream direction.

In the above-mentioned method, in which the ultrasonic wave is transmitted diagonally to the tube by the wedge-shaped ultrasonic transducers, an enough diameter of the tube is necessary for mounting the ultrasonic transducers. Moreover, the smaller diameter of the tube results in poor precision of the measurement, because the measuring distance becomes shorter. For the purpose of securing an enough distance between the upstream- and the downstream transducers, the method in which the tube is bent in rectangular and ultrasonic wave is injected along the tube axis between the rectangular parts, is widely adopted. However, in case of smaller diameter, where a cross-section of the tube is small comparing to a vibrating area of the ultrasonic transducer, enough ultrasonic energy cannot be input to the fluid in the tube.

For making possible to measure flow volume through a narrow tube, a method using annular ultrasonic transducers has been devised as shown in JP-A-8-86675 (Hei). In this method two annular ultrasonic transducers such as annular piezoelectric elements are set at a distance as penetrated by a straight tube. By this method ultrasonic measurement of a flow speed through a narrow tube have made possible. Moreover, the measurement is not influenced by flow speed distribution within the cross-section of the tube, such as laminar flow or turbulent flow, because the ultrasonic wave propagates through a whole cross-section. Therefore, this method has an advantage that a mean flow speed can be measured at minute flow through the measuring tube of a small diameter as a few millimeters or less. Also this method has an advantage that measuring sensitivity increases by increasing the running time difference between upstream- and downstream direction, because this method can set the ultrasonic transducers of the upstream side and downstream side by securing an enough distance between them.

However, the flow volume measurement employing the annular ultrasonic transducers has problem to be solved that the propagation velocity of ultrasonic wave is influenced by vibration of the tube. In principle, the ultrasonic flowmeter can measure a flow speed notwithstanding differences in the sound velocity among fluids. Namely, if a sound velocity in fluid is c, a flow speed of fluid is V, a distance between the two ultrasonic transducers is L, a downstream running time of the ultrasonic wave is T₁, and an upstream running time of the ultrasonic wave is T₂, the expressions; T₁=L/(c+V) and T₂=L/(c−V) can be introduced. By expressing the difference between the upstream running time and the downstream running time as ΔT, expressing the mean of the upstream running time and the downstream running time as T₀, and taking c>>V into consideration, the above expressions are transformed to V=ΔT·L/(2T₀²). This expression means that the flow speed V can be obtained without particularly knowing the sound velocity c in the fluid.

In some reference books it is described on the basis of the above expression that ultrasonic flowmeters can measure a flow volume without knowing a sound velocity in the fluid. However, the above expression is valid practically only in the case where there is no influence of the measuring tube. Therefore, by the ultrasonic flowmeter of annular ultrasonic transducer the flow speed cannot be obtained without knowing the sound velocity in the fluid, because the ultrasonic wave propagation velocity in a tube is influenced by the vibration of the tube. However, it is difficult to measure directly the sound velocity of fluid in the measuring tube of a flowmeter. Therefore, the method in which correction of the flow speed is conducted by flowing the fluid to be measured as being matched to the actual condition of temperature and pressure is widely adopted, whereas correction by theoretical formulas is abandoned. In this method, it is necessary to store data under various temperature and pressure, and to conduct correction by these data during measurement. Patent Document 1: JP-A-8-86675 (Hei)

### DISCLOSURE OF THE INVENTION

### Problem to be Solved by the Invention

This invention aims to provide an ultrasonic flowmeter of the time difference type using annular ultrasonic transducers; wherein an accurate flow volume can be obtained without correction by actual flow, from measured values of a downstream ultrasonic running time, an upstream ultrasonic running time, and period or frequency of the propagating ultrasonic wave, by calculating a sound velocity in the fluid from theoretical formulas in which properties of the fluid such as a density, and dimension and properties of the measuring tube are taken into consideration.

### Means for Solving the Problem

The ultrasonic flowmeter in accordance with the present invention for solving the above problem, which has two annular ultrasonic transducers are set at a distance each other as being penetrated by a measuring tube for flowing fluid to be measured and touching to the measuring tube, the two ultrasonic transducers are operated as an ultrasonic sender and an ultrasonic receiver alternately, and a flow speed is calculated from a downstream running time while the upstream-side ultrasonic transducer being the ultrasonic sender and an upstream running time while the downstream-side ultrasonic transducer being the ultrasonic sender; is characterized by having an ultrasonic measuring device which measures the downstream running time T₁, the upstream running time T₂, and period Tₚ or frequency fₚ of propagating ultrasonic wave; and having a computing device which conducts first calculation using following expressions (1), (2) and (3), for outputting a running-time difference ΔT, a mean running time T₀, and a natural angular frequency ω₀ by inputting the above measured data, conducts second calculation using expressions derived from an oscillation equation of a tube wall and a wave equation of propagating ultrasonic wave in the fluid, for outputting a sound velocity c in the fluid from a distance L between the two ultrasonic transducers, an inside radius a of the measuring tube, a damping coefficient R of tube wall oscillation of the measuring tube, a density ρ of the fluid, the above-mentioned T₀ and the above-mentioned ω₀, and conducts third calculation using a following expression (4), for outputting the flow speed V of the fluid from the above-mentioned ΔT, T₀, L and c.

ΔT=T₂−T₁ (1)

T₀=(T₁+T₂)/2 (2)

ω₀=2π/Tₚ=2πfₚ (3)

V=T₀c³ΔT/(2L²) (4)

Also the ultrasonic flowmeter is characterized in that the above-mentioned second calculation for outputting the sound velocity c in the fluid is conducted by using following expressions (5) and (6).

$$\begin{matrix}[ Math . 1 ] & \\ x \frac{{I}_{1} ( x )}{{I}_{0} ( x )} = a {ω}_{0} \frac{ρ}{R} & ( 5 ) \\ [ Math . 2 ] & \\ c = \frac{1}{\sqrt{{( \frac{{T}_{0}}{L} )}^{2} - {( \frac{x}{a {ω}_{0}} )}^{2}}} & ( 6 )\end{matrix}$$

Hereupon, Iₙ(x) is an n-th order modified Bessel function of the first kind.

### ADVANTAGEOUS EFFECT OF THE INVENTION

The flowmeter of this invention is able to obtain a flow volume from the downstream running time, the upstream running time, and the period or frequency of propagating ultrasonic wave, without correction by actual flow of the fluid to be measured, because it obtains a flow speed by estimating oscillation of a tube wall of the measuring tube on the basis of mechanical coefficients of the tube wall, and finding out a propagation velocity of the ultrasonic wave in the fluid. Therefore, an accurate flow volume can be obtained for every fluid which can propagate ultrasonic wave, notwithstanding change of conditions as temperature, pressure and so on.

### BRIEF DESCRIPTION OF THE DRAWINGS

FIG. 1 Schematic view of the principal part of the ultrasonic measuring device

FIG. 2 Block diagram showing construction of the control part of the ultrasonic measuring device

FIG. 3 Diagram showing a received wave pattern of the ultrasonic wave

### EXPLANATION OF REFERENCES

1 Measuring tube
2 Upstream-side ultrasonic transducer
3 Downstream-side ultrasonic transducer
4 Fitting material
7 Changeover switch
8 Changeover-switch control part
9 Electric pulse generating part
10 Signal amplifier
11 Measuring and computing part

### BEST MODE FOR CARRYING OUT THE INVENTION

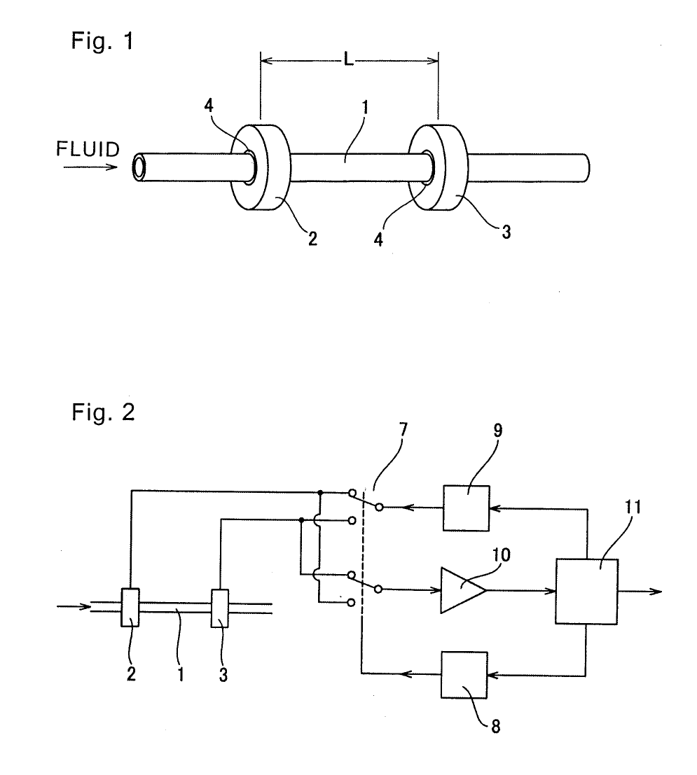

The flowmeter of this invention is composed of an ultrasonic measuring device, which contains mainly a measuring tube and ultrasonic transducers, and a computing device, which outputs finally a flow speed or a flow volume by inputting the measured data. FIG. 1 is a schematic view of the principal part, namely, a measuring tube and others, of the ultrasonic measuring device. It shows that a upstream-side ultrasonic transducer 2 and a downstream-side transducer 3, which are annular and oscillate radially, are set at a distance L each other as being penetrated by a straight measuring tube 1 and touching to the measuring tube, which flow fluid to be measured. Material of the measuring tube is, for instance, PFA resin (Tetrafluoroethylene perfluoroalkoxy vinyl ether copolymer). The ultrasonic transducers are fixed to the measuring tube by inserting fitting material 4, in order to ensure adequate propagation of ultrasonic wave between the inner surfaces of the ultrasonic transducers and the outer surface of the measuring tube. The upstream-side ultrasonic transducer 2 and the downstream-side transducer 3 are operated as an ultrasonic sender and an ultrasonic receiver each other alternately.

FIG. 2 is a block diagram showing construction of the control part of the ultrasonic measuring device. The upstream-side ultrasonic transducer 2 and the downstream-side transducer 3 are respectively connected to an electric pulse generating part 9 and a signal amplifier 10 alternately, through a two-circuits interlocking changeover switch 7. In FIG. 2, numeral 8 is a changeover-switch control part and numeral 11 is a measuring and computing part. The measuring and computing part 11 sends control signals to the changeover-switch control part 8 and the electric pulse generating part 9, and also outputs measured data, which are downstream running time, upstream running time, period or frequency of propagating ultrasonic wave and so on, by inputting signals from the signal amplifier 10.

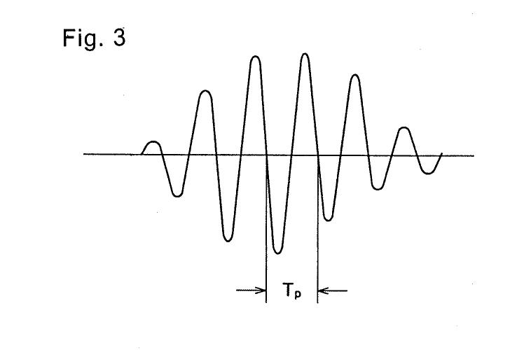

The upstream-side ultrasonic transducer 2 is connected to the electric pulse generating part 9 and the downstream-side transducer 3 is connected to the signal amplifier 10 at the position of the changeover switch 7 shown in FIG. 2. Hereupon, the measuring and computing part 11 measures a lapse time from the time when an electric pulse is generated, to the time when the ultrasonic wave is received, then, the lapse time corresponds to the downstream running time T₁. In the same manner, the upstream running time T₂ can be obtained by switching the changeover switch 7 from the position shown in FIG. 2. Also the measuring and computing part 11 measures period Tₚ or frequency fₚ (=1/Tₚ) of the ultrasonic wave, which is input into the measuring and computing part 11 through the signal amplifier 10, wherein the pattern of the received ultrasonic wave is as shown in FIG. 3. Besides, the frequency fₚ of the received ultrasonic wave is different from the oscillating frequency of the ultrasonic transducers, but the frequency is settled by the factors as vibration of the wall of the measuring tube and so on. In the flowmeter of this invention, the oscillating frequency itself of the ultrasonic transducers does not participate in the measured value of the flow speed of fluid.

The downstream running time T₁, the upstream running time T₂, and the period Tₚ or frequency fₚ of the ultrasonic wave, which are measured as described above, are sent to a computing device. To begin with, the computing device conducts first calculation using the following expressions (1), (2) and (3), for outputting a running-time difference ΔT, a mean running time T₀, and a natural angular frequency ω₀. It will be needless to explain about these expressions, because these expressions are showing the definitions itself of the running-time difference ΔT, the mean running time T₀, and the natural angular frequency ω₀.

ΔT=T₂−T₁ (1)

T₀=(T₁+T₂)/2 (2)

ω₀=2π/Tₚ=2πfₚ (3)

Next, the computing device conducts second calculation, which outputs a sound velocity c in the fluid from T₀ and ω₀ which have been obtained by the first calculation, a distance L between the ultrasonic transducers, an inner radius a of the measuring tube, a damping coefficient R of the tube wall oscillation of the measuring tube, and the density ρ of the fluid to be measured. The second calculation for outputting the sound velocity c is conducted by using the following expressions (5) and (6). Hereupon, Iₙ(x) is an n-th order modified Bessel function of the first kind.

$$\begin{matrix}[ Math . 3 ] & \\ x \frac{{I}_{1} ( x )}{{I}_{0} ( x )} = a {ω}_{0} \frac{ρ}{R} & ( 5 ) \\ [ Math . 4 ] & \\ c = \frac{1}{\sqrt{{( \frac{{T}_{0}}{L} )}^{2} - {( \frac{x}{a {ω}_{0}} )}^{2}}} & ( 6 )\end{matrix}$$

The above-mentioned expressions of the second calculation for obtaining the sound velocity in the fluid have been lead theoretically on the basis of an oscillation equation of the tube wall and a wave equation of the propagating ultrasonic wave in the fluid. Hereafter, the method for leading the expressions of the second calculation will be explained practically.

Assuming that a tube of an inside radius a is filled with fluid of density ρ, and then, the tube wall which has a thickness h, a Young's modulus (modulus of longitudinal elasticity) E₁ and density ρ₁ is oscillating by pressure from the fluid inside. In h, a Young's modulus (modulus of longitudinal elasticity) E₁ and density ρ₁ is oscillating by pressure from the fluid inside. In this situation the following oscillation equation (7) of the tube wall is valid concerning a radial displacement e of the tube wall.

$$\begin{matrix}[ Math . 5 ] & \\ {ρ}_{1} h \frac{{d}^{2} e}{d {t}^{2}} + R \frac{d e}{d t} + \frac{{E}_{1}}{a} e = - ρ \frac{d φ}{d t} & ( 7 )\end{matrix}$$

Hereupon, Φ is a velocity potential of the ultrasonic wave, and R is a damping coefficient of the tube wall oscillation. Besides, the velocity potential is scalar quantity, and there is relation that a gradient of the velocity potential is a particle velocity which is vector quantity. The approximate solution of the equation (7) is the following expression (8) in the stationary state.

$$\begin{matrix}[ Math . 6 ] & \\ e = - \frac{ρ}{{ρ}_{1} h} \frac{1}{\frac{{E}_{1}}{{ρ}_{1} ha} - {ω}^{2} + jω \frac{R}{{ρ}_{1} h}} \frac{d φ}{d t} & ( 8 )\end{matrix}$$

Here, by assuming that the tube wall is vibrating in a natural angular frequency ω₀, the expression (8) is transformed to the expression (10) by inputting the expression (9).

$$\begin{matrix}\frac{{E}_{1}}{{ρ}_{1} ha} = {ω}_{0}^{2} & ( 9 ) \\ [ Math . 8 ] & \\ e = - \frac{1}{{jω}_{0}} \frac{ρ}{R} \frac{d φ}{d t} & ( 10 )\end{matrix}$$

On the other hand, for the liquid in the measuring tube, the oscillation equation (11) of the propagation of ultrasonic wave is valid in relation to the velocity potential Φ of the ultrasonic wave and the sound velocity c in the fluid. Here, r and z is a radial and an axial position at the cylindrical coordinates respectively.

$$\begin{matrix}[ Math . 9 ] & \\ \frac{{\partial }^{2} φ}{\partial {r}^{2}} + \frac{1}{r} \frac{\partial φ}{\partial r} + \frac{{\partial }^{2} φ}{\partial {z}^{2}} = \frac{1}{{c}^{2}} \frac{{\partial }^{2} φ}{\partial {t}^{2}} & ( 11 )\end{matrix}$$

Now, the velocity potential Φ is represented as the expression (12) by assuming that the ultrasonic wave propagates with the angular frequency ω and the propagation velocity c₁ in the tube. Then, the expression (13) is obtained by putting the expression (12) into the expression (11).

$$\begin{matrix}[ Math . 10 ] & \\ φ = Af ( r ) exp jω ( t - \frac{z}{{c}_{1}} ) & ( 12 ) \\ [ Math . 11 ] & \\ \frac{{d}^{2} f}{d {r}^{2}} + \frac{1}{r} \frac{d f}{d r} - {ω}^{2} ( \frac{1}{{c}_{1}^{2}} - \frac{1}{{c}^{2}} ) f = 0 & ( 13 )\end{matrix}$$

Hereupon, by substituting the expression (14) for the third term of the expression (13) and putting the expression (15) into the expression (13), the expression (13) is transformed to the expression (16).

$$\begin{matrix}[ Math . 12 ] & \\ {ω}^{2} ( \frac{1}{{c}_{1}^{2}} - \frac{1}{{c}^{2}} ) = {γ}^{2} & ( 14 )\end{matrix}$$

x=γr (15)

$$\begin{matrix}[ Math . 13 ] & \\ \frac{{d}^{2} f}{d {x}^{2}} + \frac{1}{x} \frac{d f}{d x} - f = 0 & ( 16 )\end{matrix}$$

The expression (16) is a modified Bessel's differential equation, the solution of which is f=I₀(x). Here, Iₙ(x) is an n-th order modified Bessel function of the first kind, which has relation of the expression (17) between the Bessel function of the first kind Jₙ(x) which is the most basic one among Bessel functions.

$$\begin{matrix}{I}_{n} ( x ) = {e}^{- n πi / 2} {J}_{n} ( {e}^{π i / 2} x ) [ - π < arg x < π / 2 ] \\ = {e}^{3 n π i / 2} {J}_{n} ( {e}^{- 3 πi / 2} x ) [ - π / 2 < arg x < π ]\end{matrix} \qquad ( 17 )$$

Here, the following expression (18) is obtained by putting the expression (12) into the aforementioned expression (10), which gives the radial displacement e of the tube wall, and then, expressing by using the above-explained Iₙ(x).

$$\begin{matrix}[ Math . 14 ] & \\ e = - {AI}_{0} ( x ) \frac{ρ}{R} exp jω ( t - \frac{z}{{c}_{1}} ) & ( 18 )\end{matrix}$$

On the other hand, a radial displacement ξ of fluid in the tube is obtained from the velocity potential Φ as the following expression (19), into which the aforementioned expression (12) is put.

$$\begin{matrix} [ Math . 15 ] & \\ ξ = \int ( - \frac{\partial φ}{\partial r} ) d t = - A \frac{d f}{d r} \frac{1}{jω} exp jω ( t - \frac{z}{{c}_{1}} ) & ( 19 )\end{matrix}$$

The expression (19) is transformed to the following expression (20) by rewriting the differential term by putting the aforementioned expression (15), namely, the relation of x=γr, into the expression (19), and taking I₀′(x)=I₁(x) into consideration.

$$\begin{matrix}[ Math . 16 ] & \\ ξ = - A γ {I}_{1} ( x ) \frac{1}{jω} exp jω ( t - \frac{z}{{c}_{1}} ) & ( 20 )\end{matrix}$$

Here, we assume that the radial displacement e of the tube wall and the radial displacement ξ of the fluid in the tube coincide in amplitude and phase at the boundary condition of r=a (a is an inside radius of the measuring tube). Then, the following expression (5), which is one of the aforementioned two expressions for the second calculation, is obtained by putting both of the right sides of the expression (18) for e and the expression (20) for ξ as equal, and arranging that expression with taking x=γa from the expression (15) into consideration.

$$\begin{matrix}[ Math . 17 ] & \\ x \frac{{I}_{1} ( x )}{{I}_{0} ( x )} = a {ω}_{0} \frac{ρ}{R} & ( 5 )\end{matrix}$$

Further, the expression (14) is transformed to the following expression (21) by putting x²=(γa)², which is derived from the expression (15), into the expression (14) and arranging that expression.

$$\begin{matrix}[ Math . 18 ] & \\ \frac{1}{{c}_{1}^{2}} = \frac{1}{{c}^{2}} + \frac{1}{{( \frac{a {ω}_{0}}{x} )}^{2}} & ( 21 )\end{matrix}$$

Here, there is relation of the following expression (22) among the propagation velocity c₁ of the ultrasonic wave in the tube, the distance L between the ultrasonic transducers and the mean running time T₀. Therefore, the following expression (6), which is the other of the aforementioned two expressions for the second calculation, is obtained by putting the expression (22) into the expression (21), and arranging that expression.

c₁=L/T₀ (22)

$$\begin{matrix}[ Math . 19 ] & \\ c = \frac{1}{\sqrt{{( \frac{{T}_{0}}{L} )}^{2} - {( \frac{x}{a {ω}_{0}} )}^{2}}} & ( 6 )\end{matrix}$$

Next, the computing device conducts third calculation, which outputs a flow speed V of the fluid which is the aim of measurement in this invention, from the distance L between the ultrasonic transducers, the running-time difference ΔT and the mean running time T₀ which have been obtained by the first calculation, and the sound velocity c in the fluid which has been obtained by the second calculation. The output of V by the third calculation is conducted by the following expression (4) which was mentioned before.

V=T₀c³ΔT/(2L²) (4)

The above expression for the third calculation can be obtained as follows. To begin with, an infinitesimal variation Δc₁ of the propagation velocity c₁ of the ultrasonic wave in the tube, which is caused by a infinitesimal variation Δc of the velocity c of the ultrasonic wave in the fluid, is expressed by the following expression (23).

$$\begin{matrix}[ Math . 20 ] & \\ Δ {c}_{1} = \frac{d {c}_{1}}{d c} Δ c & ( 23 )\end{matrix}$$

On the other hand, the following expression (24) is obtained by differentiate the both sides of the expression (21) by c and arranging that expression, because ω₀ and x are constant for the variation of c.

$$\begin{matrix}[ Math . 21 ] & \\ \frac{d {c}_{1}}{d c} = {( \frac{{c}_{1}}{c} )}^{3} & ( 24 )\end{matrix}$$

Meantime, the running-time difference ΔT of ultrasonic wave is expressed by the following expression (25).

$$\begin{matrix}[ Math . 22 ] & \\ Δ T = \frac{L}{{c}_{1} - Δ {c}_{1}} + \frac{L}{{c}_{1} + Δ {c}_{1}} = 2 \frac{L}{{c}_{1}^{2}} Δ {c}_{1} & ( 25 )\end{matrix}$$

This expression (25) is transformed to the following expression (26) by inputting the expressions (23) and (24). Because the infinitesimal variation Δc of the velocity c of the ultrasonic wave in the fluid corresponds to the flow speed V of the fluid, the following expression (4) for the third calculation is obtained by substituting V for Δc in the expression (26), putting the expression (22) into the expression (26) and arranging that expression.

ΔT=2L(c₁/c³)Δc (26)

V=T₀c³ΔT/(2L²) (4)

Besides, the above calculation outputs the flow speed V which is a mean flow speed across the cross-section of the measuring tube. So the flow volume Q can be obtained immediately by the following expression (27) by introducing an inside radius a of the measuring tube.

Q=πa²V (27)

As explained above, in this invention a flow speed and also a flow volume can be obtained by calculation on the basis of the measured value of the downstream running time T₁, the upstream running time T₂, and period Tₚ or frequency fₚ of propagating ultrasonic wave. For conducting the above calculation, the data are necessary which are the distance L between the ultrasonic transducers, the inside radius a of the measuring tube, the damping coefficient R of the tube wall oscillation of the measuring tube, and the density ρ of the fluid to be measured. Among these data, L and a are inherent to the ultrasonic flowmeter to be used. As for the density ρ of the fluid to be measured, its data at the measuring temperature can be prepared previously.

Concerning the damping coefficient R of the tube wall oscillation of the measuring tube, theoretically it is determined by material of the measuring tube, therefore, it is inherent to the ultrasonic flowmeter to be used. It can be measured by using fluid, for instance, water, about which sound velocity at some temperature is known by physical data tables or so. Namely, value of x can be found out by conducting measurement by filling water or so in the ultrasonic flowmeter to be used; then, obtaining the mean running time T₀, and the natural angular frequency ω₀; and then, putting into the aforementioned expression (6) these obtained values, and the sound velocity c, the distance L between the two ultrasonic transducers and the inside radius a of the measuring tube which are already known as explained before. Then, the damping coefficient R of the tube wall oscillation of the measuring tube can be obtained by inputting into the expression (5) the above value of x, the measured natural angular frequency ω₀, the known density ρ of the fluid to be measured (water, in this case) and the inside radius a of the measuring tube.

As explained above, the damping coefficient R of the tube wall oscillation of the measuring tube is determined essentially by material of the measuring tube, however, it is confirmed by the inventor's experiment that it is influenced by kinds of fluid to some extent. For instance, in the case that the measuring tube is aforementioned PFA resin and temperature is 24 to 25° C., the results are 2.52 kg/(s·m²)×10⁶ at city water, 2.53 (unit is same as before) in 80 vol % ethanol and 2.57 in edible oil. Therefore, high precision measurement can be attained by previously determining the value of R for the fluid to be measured and setting the value in the computer. Besides, in order to determine the value of R by the above-explained calculating steps, it is necessary to know the sound velocity c in the fluid to be measured. It can be obtained experimentally by known methods such as conducting measurement while two ultrasonic transducers are set in countered position in the fluid.

### INDUSTRIAL APPLICABILITY

This invention contributes to conduct correction of ultrasonic flowmeter by calculation without experiment which uses actual flow of the fluid, in relation to condition of the fluid to be measured, such as kind, temperature and pressure. Therefore, accurate flow volume is determined because variation of conditions such as temperature and pressure is easily dealt with.

1. An ultrasonic flowmeter, wherein two annular ultrasonic transducers are set at a distance each other as being penetrated by a measuring tube for flowing fluid to be measured and touching to the measuring tube, the two ultrasonic transducers are operated as an ultrasonic sender and an ultrasonic receiver alternately, and a flow speed is calculated from a downstream running time while the upstream-side ultrasonic transducer being the ultrasonic sender and an upstream running time while the downstream-side ultrasonic transducer being the ultrasonic sender; characterized by having an ultrasonic measuring device which measures the downstream running time T₁, the upstream running time T₂, and period Tₚ or frequency fₚ of propagating ultrasonic wave; and having a computing device which conducts first calculation using following expressions (a), (b) and (c), for outputting a running-time difference ΔT, a mean running time T₀, and a natural angular frequency ω₀ by inputting the above measured data, conducts second calculation using expressions derived from an oscillation equation of a tube wall and a wave equation of propagating ultrasonic wave in the fluid, for outputting a sound velocity c in the fluid from a distance L between the two ultrasonic transducers, an inside radius a of the measuring tube, a damping coefficient R of tube wall oscillation of the measuring tube, a density ρ of the fluid, the aforesaid T₀ and the aforesaid ω₀, and conducts third calculation using a following expression (d), for outputting the flow speed V of the fluid from the aforesaid ΔT, T₀, L and c.
ΔT=T₂−T₁ (a)
T₀=(T₁+T₂)/2 (b)
ω₀=2π/Tₚ=2πfₚ (c)
V=T₀c³ΔT/(2L²) (d)

2. The ultrasonic flowmeter according to claim 1, characterized in that the second calculation for outputting the sound velocity c in the fluid is conducted by using following expressions (e) and (f).
$$\begin{matrix}[ Math . 1 ] & \\ x \frac{{I}_{1} ( x )}{{I}_{0} ( x )} = a {ω}_{0} \frac{ρ}{R} & ( e ) \\ [ Math . 2 ] & \\ c = \frac{1}{\sqrt{{( \frac{{T}_{0}}{L} )}^{2} - {( \frac{x}{a {ω}_{0}} )}^{2}}} & ( f )\end{matrix}$$
Hereupon, Iₙ(x) is an n-th order modified Bessel function of the first kind.

3. The ultrasonic flowmeter according to claim 1, characterized in that the damping coefficient R of the tube wall oscillation of the measuring tube of the flowmeter to be used is previously obtained for the fluid to be measured, and set in the computing device.

4. The ultrasonic flowmeter according to claim 2, characterized in that the damping coefficient R of the tube wall oscillation of the measuring tube of the flowmeter to be used is previously obtained for the fluid to be measured, and set in the computing device.
